(19) United States
(12) Patent Application Publication
(10) Pub. No.: US 2009/0051685 A1
(43) Pub. Date: Feb. 26, 2009

(54) STEREOSCOPIC IMAGE DISPLAY APPARATUS

(76) Inventors: Ayako Takagi, Yokosuka-Shi (JP); Kazuki Taira, Tokyo (JP); Tatsuo Saishu, Tokyo (JP); Hitoshi Kobayashi, Kawasaki-Shi (JP); Yoshiharu Momonoi, Yokohama-Shi (JP); Yuzo Hirayama, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/187,617

(22) Filed: Aug. 7, 2008

(30) Foreign Application Priority Data
Aug. 21, 2007 (JP) 2007-214632

(51) Int. Cl. G06T 15/00

(52) U.S. Cl. 345/419

(57) ABSTRACT

A stereoscopic image display apparatus includes: a plane display device including a display panel formed of pixels arranged in a matrix form and an image display controller controlling an image displayed on the display panel; an optical plate including a plurality of lenses provided in front of the display panel and controlling light rays illuminated from the pixels; a display mode selector selecting one of stereoscopic image display and two-dimensional image display as a display mode; an analyzer analyzing image information contained in a two-dimensional image displayed based on a display information and determine whether to process the two-dimensional image when two-dimensional image display as a display mode be selected; and an image processor processing the two-dimensional image based on a result of the analysis conducted by the analyzer, sending the processed two-dimensional image to the image display controller, and causing the image display controller to display the processed two-dimensional image on the display panel.

### CROSS-REFERENCE TO RELATED APPLICATION

This application is based upon and claims the benefit of priority from prior Japanese Patent Application No. 2007-214632 filed on Aug. 21, 2007 in Japan, the entire contents of which are incorporated herein by reference.

### BACKGROUND OF THE INVENTION

1. Field of the Invention

The present invention relates to a stereoscopic image display apparatus which displays a stereoscopic image.

2. Related Art

A method of recording a stereoscopic image by using some method and reproducing it as a stereoscopic image is known. This method is called integral photography (hereafter referred to as IP method as well) or light ray reproduction method, and a large number of parallax images are displayed in this method. It is supposed that an object is viewed with left and right eyes. When a point A located at a short distance is viewed, an angle formed by the point A and the left and right eyes is denoted by α. When a point B located at a long distance is viewed, an angle formed by the point B and the left and right eyes is denoted by β. The angles α and β vary depending upon the location relation between the object and the viewer. The difference (α−β) is called binocular parallax. Human being is sensitive to the binocular parallax and is able to conduct stereoscopic viewing.

A conventional stereoscopic image display apparatus includes a plane display device having pixels arranged in a two-dimensional form, and an optical plate which is provided on the front of a display screen of the plane display device, which has a plurality of lenticular lenses or slits, and which controls light rays emitted from the pixels. Stereoscopic image display is made possible by utilizing the above-described binocular parallax and controlling the angle of light rays emitted from the plane display device so as to cause light rays to appear to be illuminated from objects located several cm before and behind the plane display device when viewed by a viewer. This is because it has become possible to obtain an image which is high in definition to some degree even if light rays of the plane display device are distributed to several kinds of angles (called parallaxes), owing to implementation of the plane display device having a higher definition. A stereoscopic (hereafter referred to as 3D as well) display method implemented by thus applying the IP method to the plane display device is called II (integral imaging) scheme. In the II scheme, the number of light rays illuminated from one lens or slit corresponds to the number of element image groups. The number of the element image groups is typically called number of parallaxes. In each lens or slit, parallax rays are illuminated in parallel.

When attempting a two-dimensional image (hereafter referred to as 2D image as well) in such a stereoscopic image display apparatus, the optical action of the optical plate provided on the front face or the back face of the display screen is removed and high definition plane display of the plane display device itself having pixels arranged in a two-dimensional form is conducted in some cases. It is possible to change over between the two-dimensional image display and the stereoscopic image display by removing the optical action of the optical plate with hardware.

On the other hand, it is known to convert an image itself to two-dimensional image display and stereoscopic image display with software without removing the optical action of the optical plate (see, for example, JP-A 2005-175538 (KOKAI) and JP-A-2005-175539 (KOKAI)). In JP-A 2005-175538 (KOKAI), a two-dimensional image is processed and displayed as the same viewpoint images. In JP-A 2005-175539 (KOKAI), a two-dimensional image in a correct location is generated from among parallax images according to the viewing direction. In JP-A 2005-175538 (KOKAI) and JP-A 2005-175539 (KOKAI), however, it is not mentioned that an optimum two-dimensional image is generated according to the image kind.

In the stereoscopic image display apparatus, image information is displayed on the plane display device (for example, a liquid crystal display device) which has pixels arranged in a two-dimensional form and which is disposed on the front face or the back face of the optical plate for generating parallax information. One pixel on the stereoscopic image display apparatus includes a plurality of elemental images corresponding to the number of parallaxes which corresponds to parallax image information. When displaying a two-dimensional image, the same image information is displayed in all elemental images (hereafter referred to as all parallax same image display). Since parallax disappears, therefore, two-dimensional image display can be conducted. If the all parallax same image display is conducted, then two-dimensional image display in which a two-dimensional image is displayed in the viewing zone range becomes possible. Especially in the case of multi-parallax (N parallax), however, the resolution falls in the all parallax same image display and the quality of the two-dimensional image display is degraded.

Even in a stereoscopic image display apparatus which is not equipped with means for changing over between the two-dimensional image display and the stereoscopic image display with hardware as described in BACKGROUND OF THE INVENTION, it is desired to conduct software image processing so as not to cause a viewer to feel degradation in resolution.

As for the two-dimensional image information, there is two-dimensional image information demanded to have a high resolution and there is two-dimensional image information which is allowed to have a low resolution according to the kind of the image. Changing the display method for the two-dimensional image display according to the image kind is effective in reducing the display degradation. However, its criteria are not known.

### SUMMARY OF THE INVENTION

The present invention has been made in view of these circumstances, and an object of thereof is to provide a stereoscopic image display apparatus capable of generating an optimum two-dimensional image according to the image kind.

A stereoscopic image display apparatus according to an aspect of the invention includes: a plane display device comprising a display panel formed of pixels arranged in a matrix form and an image display controller which controls an image displayed on the display panel; an optical plate comprising a plurality of lenses provided in front of the display panel and controlling light rays illuminated from the pixels; a display mode selector configured to select one of stereoscopic image display and two-dimensional image display as a display mode; an analyzer configured to analyze image information contained in a two-dimensional image displayed based on a display information and determine whether to process the two-dimensional image when two-dimensional image display as a display mode be selected; and an image processor configured to process the two-dimensional image based on a result of the analysis conducted by the analyzer, send the processed two-dimensional image to the image display controller, and cause the image display controller to display the processed two-dimensional image on the display panel.

### BRIEF DESCRIPTION OF THE DRAWINGS

FIG. 1 is a block diagram showing a stereoscopic image display apparatus according to an embodiment;

FIG. 2 is a block diagram showing a processing procedure for two-dimensional image generation in a stereoscopic image display apparatus according to an embodiment;

FIG. 3 is a flow chart showing a two-dimensional image generation method in a stereoscopic image display apparatus according to an embodiment;

FIG. 4 is a diagram showing a two-dimensional image in which a spatial frequency in the vertical direction is high;

FIG. 5 is a diagram showing a display image of appearance obtained when the two-dimensional image shown in FIG. 4 is simply enlarged;

FIG. 6 is a diagram showing a display image of appearance obtained when the two-dimensional image shown in FIG. 4 is subjected to all parallax same image display;

FIG. 7 is a diagram for explaining an example of an interpolation method for determining pixel information of all parallax same image display;

FIG. 8 is a diagram for explaining a method for determining pixel information when the interpolation of all parallax same image display is not used;

FIG. 9 is a diagram showing elemental image information in one lens;

FIG. 10 is a diagram showing elemental image information in one lens obtained when all parallax same image display is conducted;

FIGS. 11(a) and 11(b) are diagrams showing an example in which an absolute value of a difference between an inclination angle θₖ and an inclination angle θₜ is less than 20 degrees;

FIGS. 12(a) and 12(b) are diagrams showing an example in which an absolute value of a difference between an inclination angle θₖ and an inclination angle θₜ is greater than 20 degrees;

FIG. 13 is a diagram showing images, for various angles, of a straight line having a thickness of two pixels;

FIG. 14 is a diagram showing images, for various angles, of a straight line having a thickness of two pixels;

FIG. 15 is a diagram showing disturbance evaluation of line segments of a plurality of kinds;

FIGS. 16(a) to 16(h) are diagrams showing a procedure of a two-dimensional image generation method in a stereoscopic image display apparatus according to an embodiment;

FIG. 17 is a diagram showing difference data of the number of gray scale levels in the vertical direction, in image information in the horizontal direction in an image;

FIG. 18 is a diagram showing difference data of the number of gray scale levels in the vertical direction, in image information in the horizontal direction in an image;

FIG. 19 is a flow chart showing a two-dimensional image generation method in a stereoscopic image display apparatus according to an embodiment; and

FIG. 20 is a flow chart showing a two-dimensional image generation method in a stereoscopic image display apparatus according to an embodiment.

### DETAILED DESCRIPTION OF THE INVENTION

Hereafter, embodiments of the present invention will be described with reference to the drawings.

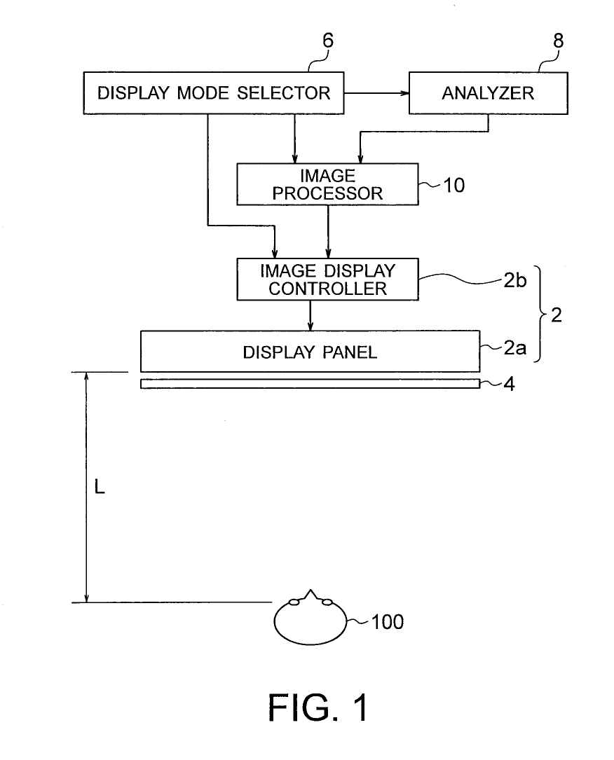

A stereoscopic image display apparatus according to an embodiment of the present invention is shown in FIG. 1. The stereoscopic image display apparatus according to the present embodiment includes a plane display device 2 including a display panel 2a having pixels arranged in a two-dimensional form and an image display controller 2b which controls image displayed on the display panel 2a, an optical plate 4 provided on the front face of the display panel 2a of the plane display device 2 to control light rays emitted from the pixels, a display mode selector 6 which selects one of the stereoscopic image display and the two-dimensional image display as a display mode, an analyzer 8 which analyzes image information contained in a two-dimensional image (hereafter referred to as 2D image) displayed on the basis of display information of a stereoscopic image (hereafter referred to as 3D image) and which determines whether to process the two-dimensional image, and an image processor 10 which processes the two-dimensional image according to a result of the analysis conducted by the analyzer 8, sends the processed two-dimensional image to the image display controller 2b, and displays the two-dimensional image on the display panel 2a.

The plane display device 2 is, for example, a liquid crystal display device. The optical plate is, for example, a plurality of lenticular lenses or slits. They are used in the known stereoscopic image display apparatus. Hereafter, embodiments will be described supposing that the plane display device 2 is a liquid crystal display device and the optical plate is a plurality of lenticular lenses.

In general, the stereoscopic image display apparatus has a configuration which displays a stereoscopic image and causes a viewer 100 located at a viewing distance L from the display panel 2a to view the stereoscopic image by limiting observable pixels to a partial pixel group included in the plane display device with the optical plate, treating the partial pixel group as one parallax, providing a plurality of parallaxes so as to successively change over recognized parallax according to the viewing direction of the plane display device, treating a direction in which parallax is viewed as an image pickup direction, generating a plurality of camera images respectively corresponding to parallaxes, and combining the camera images into one stereoscopic image so as to assign the generated camera images to the pixel groups constituting corresponding parallaxes.

The stereoscopic image display apparatus according to the present embodiment displays the two-dimensional image according to an image display method in the stereoscopic image display apparatus as camera images corresponding to all parallaxes. The stereoscopic image display apparatus according to the present embodiment has a configuration which generates one two-dimensional image having a resolution equivalent to the number of pixels of the plane display device 2 by using the analyzer 8 and the image processor 10, and displays the two-dimensional image directly on the plane display device.

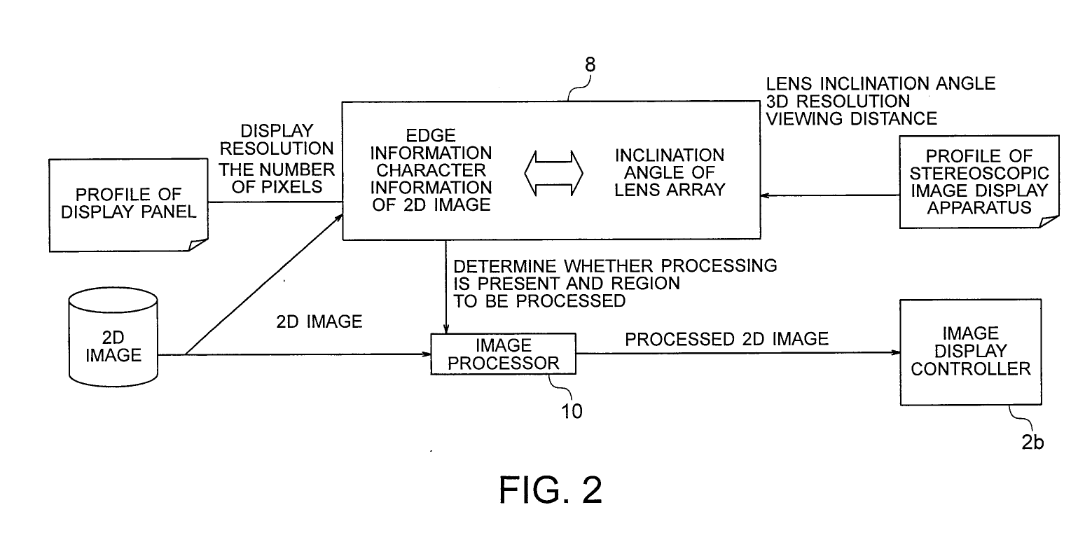

The analyzer 8 and the image processor 10 according to the present embodiment are shown in FIG. 2. The analyzer 8 receives display information of a stereoscopic image. In other words, the analyzer 8 receives information of the display resolution (for example, the number of pixels) from a profile of the display panel 2a, and receives information of lens inclination angle, the number of parallaxes (resolution of a 3D image) and the viewing distance of the optical plate 4 from a profile of the stereoscopic image display apparatus. The analyzer 8 extracts whether information of a pattern edge of a two-dimensional image to be displayed and character information are present, compares the pattern edge with the lens inclination of the optical plate 4, makes a decision whether the two-dimensional image is a character or an image, and finds a elemental image pitch from the viewing distance. The elemental image pitch is set so as to make the elemental image width on the back of the lens pitch slightly wider than the lens pitch in order to collect each of a viewing zone width per lens in the center of the screen and a viewing zone width per lens in the ends of the screen to the center. The analyzer 8 analyzes them in order to display the two-dimensional image on the stereoscopic image display apparatus by using an optimum method. The image processor 10 processes the two-dimensional image according to a result of the analysis, sends the processed two-dimensional image to the image display controller 2b, and displays the two-dimensional image on the display panel 2a.

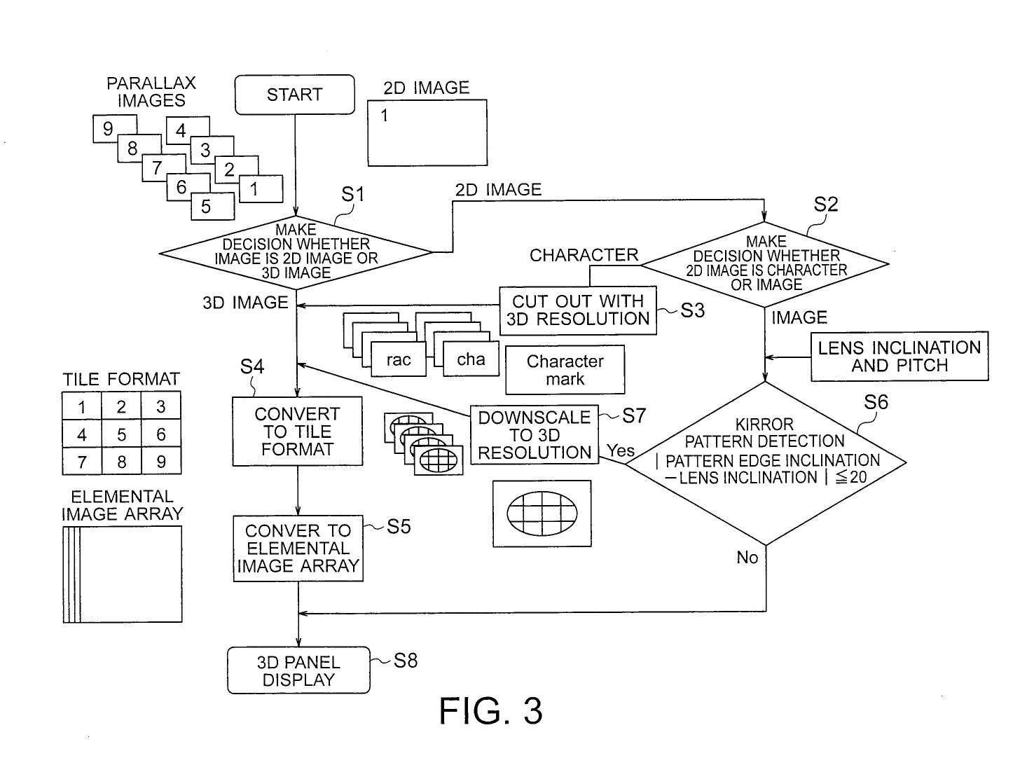

A procedure of image display in the stereoscopic image display apparatus according to the present embodiment is shown in FIG. 3.

First, the display mode selector 6 selects whether to display a 2D image or display a 3D image (step S1). As for the 3D image, a plurality of sheets of parallax image display are transmitted in, for example, one frame. As for the 2D image, one sheet of image is transmitted per frame. When displaying the 2D image, the processing proceeds to step S2. At the step S2, a decision is made whether the 2D image to be displayed is a character or an image. Characters tend to be high in spatial frequency, and are easily seen as a display as the contrast ratio between adjacent pixels becomes higher. If downscaled display is conducted in the character image demanded to be high in spatial frequency, then pixels forming the character are missing and the display is degraded very much in many cases.

When generating a component corresponding to a 3D resolution (resolution of a stereoscopic image) from plane display upon judgment of the 2D image to be a character, downscaling is not conducted, but cutout is conducted with the 3D resolution (step S3 in FIG. 3). If the resolution of the plane display is greater than the 3D resolution, a plurality of sheets are cut out in some cases. As character display having the 3D resolution, the same image is duplicated to a plurality of parallax images and delivered to the image display controller 2b. Thereafter, the parallax images are converted to the tile formats by the image display controller 2b (step S4). Subsequently, the tile formats are converted to elemental image arrays (step S5). The elemental image arrays obtained by the conversion are sent from the image display controller 2b to the display panel 2a to display the 2D image.

As one method in the case where the 2D image to be displayed is a character, the following method may also be used. For example, if characters “character mark” are included in the resolution of the two-dimensional image and cutout is conducted with the 3D resolution, then only characters “cha” can be cut out. For including all characters, therefore, the number of frames may be increased by cutting and dividing the character image of one sheet into characters of the 3D resolution of a plurality of sheets. As an alternative method, all character images can be represented by upscaling the display image by a factor of s₁(s₁=resolution of the display panel 2a in the horizontal direction/resolution of the stereoscopic image in the horizontal direction) in the horizontal direction and upscaling the display image by a factor of s₂ (s₂=resolution of the display panel 2a in the vertical direction/resolution of the stereoscopic image in the vertical direction) in the vertical direction. Because of the labor for scrolling and a resolution higher than that in the ordinary processing, however, it takes time. Unlike the case where cutout is conducted, however, a method for avoiding dividing a character in some cutout location with the 3D resolution may not be taken. If the image to be displayed is judged to be a 3D image, then the processing proceeds successively to steps S4, S5 and S8 and the 3D image is displayed on the display panel 2a.

The whole image cannot be watched at once. However, the whole image can be watched by moving the image in a displayable region. For example, it is now supposed that one pixel nearly takes the shape of a parallelogram and three pixels in resolution of the plane display device are included in the horizontal direction whereas three pixels are included in the vertical direction.

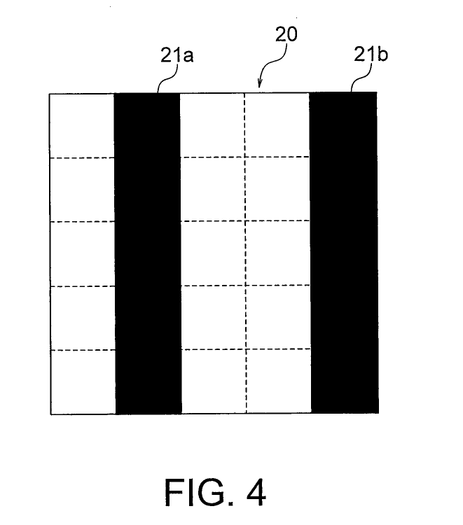

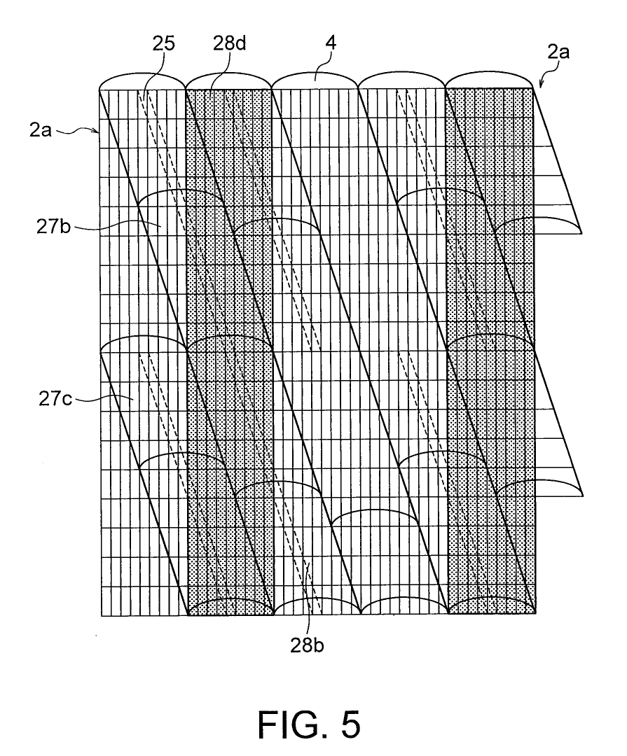

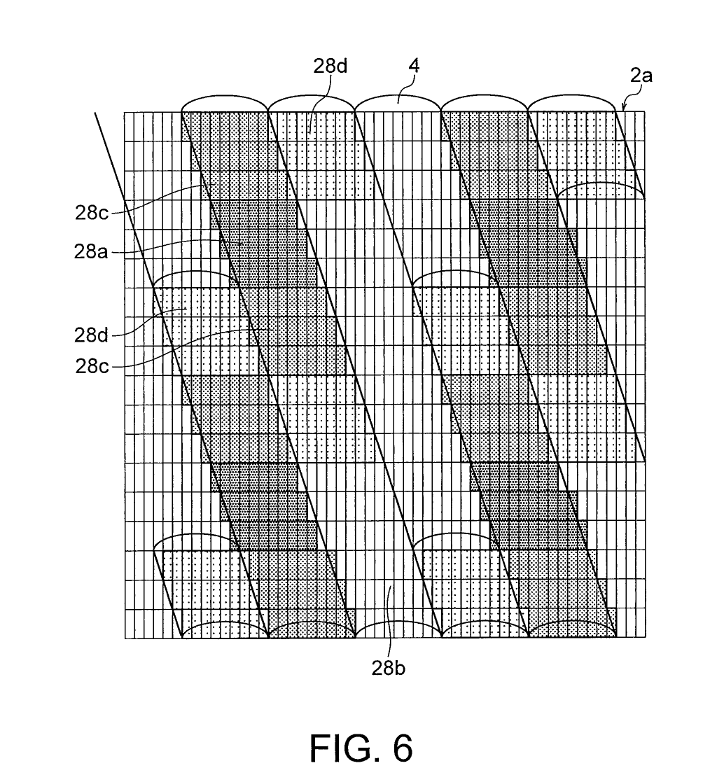

In this case, the inclination in the vertical direction is ⅓. Without considering the inclination, however, the image is upscaled simply three times in the horizontal direction and three times in the vertical direction. It will now be described with reference to FIGS. 4 to 6 that characters can be discriminated even in such display. FIG. 4 is a diagram showing a two-dimensional image in which a spatial frequency in the vertical direction is high. FIG. 5 is a diagram showing a display image of appearance obtained when the two-dimensional image shown in FIG. 4 is simply enlarged so as to have a 3D resolution in both the longitudinal direction and lateral direction. FIG. 6 is a diagram showing a display image of appearance obtained when the two-dimensional image shown in FIG. 4 is subjected to all parallax same image display.

Characters include a large number of line segments in the longitudinal direction and the lateral direction. Especially, as regards Chinese characters, the spatial frequency is high in the longitudinal direction and the lateral direction, and white and black continue every other pixel in some cases. The stereoscopic image display apparatus heretofore described has a scheme in which a lens array is used as the optical plate 4 and parallax images only nearly in the horizontal direction are subject to stereoscopic image display according to the viewing angle. Therefore, the width of the lens pitch in the horizontal direction becomes the width of one pixel, and the resolution is degraded.

It is now supposed that a two-dimensional image 20 to be displayed includes vertical lines 21a and 21b each of which has a thickness corresponding to one pixel in 3D resolution and which are arranged in parallel at a distance of two pixels between as shown in FIG. 4. A method for displaying the two-dimensional image 20 on the stereoscopic image display apparatus will now be described.

Cases where the image is processed and displayed by using the following two methods are examined.

1) As shown in FIG. 5, simple upscaling is conducted by the number of horizontal parallaxes (nine parallaxes in FIG. 5) in the horizontal direction and by the number of vertical parallaxes (nine parallaxes in FIG. 5) in the vertical direction regardless of the inclination of the lens 4.

2) As shown in FIG. 6, all parallax images are displayed as the same image according to the inclination of the lens 4. In the vertical direction, left and right images are averaged according to the inclination (FIG. 6).

A 2D image obtained when the processing and display are conducted by using the method 1) is shown in FIG. 5. A 2D image obtained when the processing and display are conducted by using the method 2) is shown in FIG. 6.

In the case of character display, a higher contrast makes the character easy to read. A great difference between FIG. 5 and FIG. 6 exists in contrast between display of two vertical black lines and display of a white line between them.

In FIG. 5, display viewed by the viewer is equivalent to display obtained by upscaling image information existing in a range 25 (indicated by dashed lines) in which parallel light rays from the viewer converge on pixels of the display panel 2a, to one lens pitch in the horizontal direction. FIG. 5 is obtained by simply upscaling the line display shown in FIG. 4 regardless of the lens inclination. Therefore, black display is seen only in regions having a black vertical line in the converging range 25 of light rays in FIG. 5. Accordingly, there are also a part 27a for which there is black display immediately under a lens 4 and an upscaled image becomes black display, a part 27b for which an upscaled image becomes black display although there is not black display immediately under a lens 4, and a part 27c for which an upscaled image becomes white display although there is black display immediately under a lens 4. In FIG. 5, there is no gray display and consequently contrast between black and white becomes clear, but notched vertical lines are displayed.

On the other hand, FIG. 6 shows a method of displaying all elemental images of one pixel of a stereoscopic image by using the same image. When displaying lines in the vertical direction, therefore, typically the elemental images displayed on the display panel 2a become areas having notched patterns ends as shown in FIG. 6. However, they can be represented as smooth straight lines by conducting the gray scale display. The luminance change ratio may be determined on the basis of how many straight lines to be displayed are included in one 3D pixel on the display panel 2a which is located on the back. For example, when attempting to display two black vertical lines on the white background as shown in FIG. 4, luminance of black is divided into three kinds as shown in FIG. 6. Image patterns are repeated with three-pixel pitch of the 3D resolution in the longitudinal direction. In other words, the basis is a 3D pixel 28a having a black display luminance 0. Here, the white luminance is set to 1 as represented by a pixel 28b, and it exists between two vertical straight lines. In 3D pixels 28c and 28d which are adjacent in the upper part in the vertical direction of the 3D pixel 28a having the black display luminance 0, the pixel 28c located on the left side has a gray display luminance of 0.33 and the pixel 28d located on the right side has a gray display luminance of 0.66. As for 3D pixels 28c and 28d of the two kinds which are adjacent in the lower part in the vertical direction, the pixel 28d located on the left side has a gray display luminance of 0.66 and the pixel 28c located on the right side has a gray display luminance of 0.33. When representing vertical straight lines with the 3D resolution, it is possible to make the notches inconspicuous by conducting such display. However, there is a demerit that a gray display area between the two black straight lines is large and the contrast between the straight lines becomes small.

In the case of character display having a high spatial frequency in which the black and white pixel pitch is one pixel in the display shown in FIG. 5 and the display shown in FIG. 6, a result of subjective evaluation indicates that simple upscaling as in the method 1) makes characters easy to read although there is degradation caused by the notches. In the case of character display having a high spatial frequency, therefore, a scheme of upscaling by the number of horizontal parallaxes and the number of vertical parallaxes is desirable as shown in 1). If the interval between the vertical lines is at least two 3D pixels as shown in FIG. 6, however, display of all elemental images using the same image as in the method 2) can be accepted as long as the display is conducted with the 3D resolution.

Referring back to FIG. 3, if the 2D image to be displayed is judged to be an image at the step S2, the processing proceeds to step S6 and killer pattern detection is conducted by the image processor 10. As for the killer pattern detection, a pattern edge of the image is taken out by using some method and a decision is made as to whether the following relation

|inclination of pattern edge−inclination of lens 4|≦20 degrees (1)

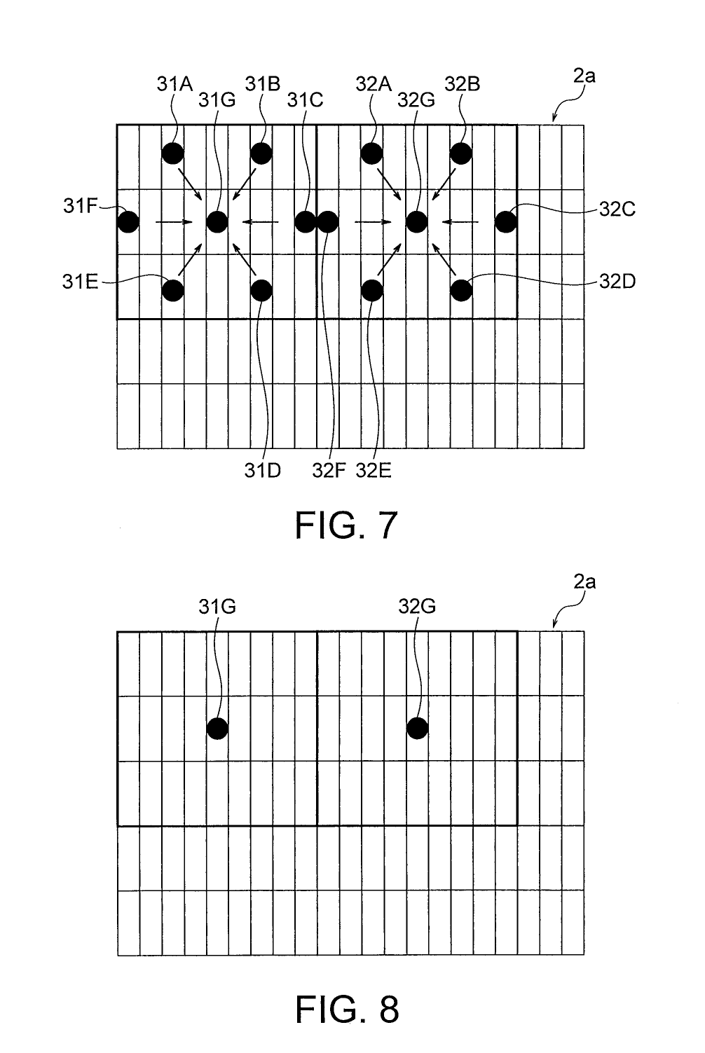

is satisfied. If the pattern edge satisfying Expression (1) continues so as to be capable of being recognized visually, then the two-dimensional image is downscaled to the 3D resolution (step S7) and all parallax images are made the same image (steps S4, S5 and S8). At the time of downscaling, discontinuity from adjacent images at the 3D resolution is mitigated and degradation in resolution becomes inconspicuous by finding a pixel 31G or 32G on the basis of interpolation from adjacent pixels 31A to 31F or 32A to 32F as shown in FIG. 7. In some cases, however, only information of the representative image 31G or 32G is extracted at the time of downscaling. In this case, there is an advantage that the processing speed becomes fast although the picture quality is degraded.

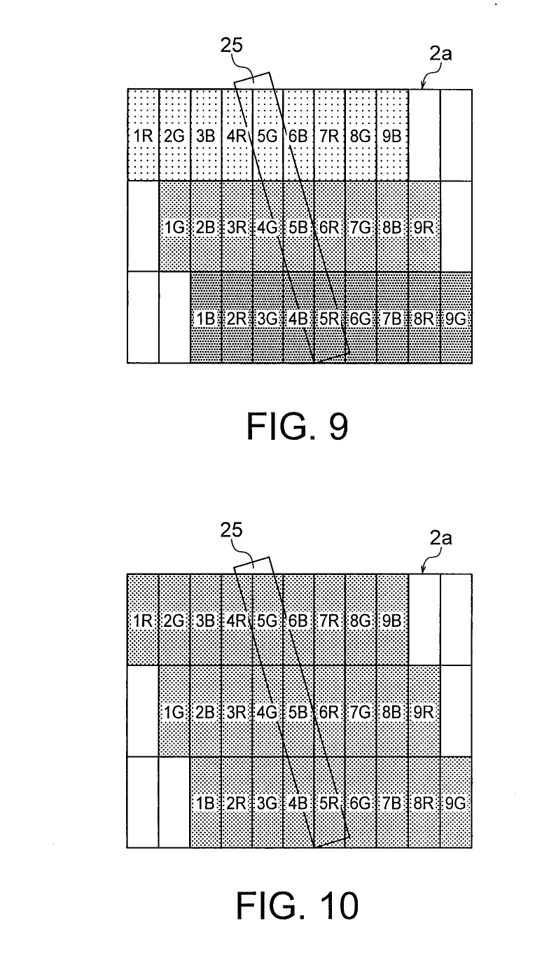

If the 2D image to be displayed is not a character image, either and the inclination of the vector does not satisfy Expression (1), a two-dimensional image having the original resolution of the display panel 2a is displayed without processing. The reason why the resolution increases when displayed without processing will now be described with reference to FIGS. 9 and 10.

FIG. 9 shows a case having image information which changes so as to become thick in color as the location proceeds downward in the longitudinal direction. FIG. 9 shows information of elemental image on the display panel 2a. Since display is conducted with the resolution of the display panel 2a, the color changes even in one pixel having the 3D resolution. Image information which is three times the 3D resolution is displayed in the longitudinal direction of the lens 4. An example of a conversion region of light rays 25 on the lens of parallel light rays seen from the viewer side is shown in FIG. 9. In the 3D resolution, color information is kept by exhibiting red (R), blue (B) and green (G) of one parallax pixel in the longitudinal direction. Since the longitudinal resolution which is location information is increased to three times in image information, however, each color information in the longitudinal direction becomes insufficient accordingly. Since image information other than character display is large in correlation of adjacent pixel information, however, subjective evaluation becomes higher because of maintenance of definition of information of the two-dimensional image caused by an increase of the resolution in the longitudinal direction as compared with degradation caused by color missing.

On the other hand, if all parallax same image display is conducted, all elemental images having the 3D resolution become the same information as shown in FIG. 10. Therefore, the resolution of the two-dimensional image on the stereoscopic image display apparatus shown in FIG. 10 is degraded to the 3D resolution, and consequently the subjective evaluation becomes low.

If the image to be displayed is not a character image and the inclination of the vector does not satisfy Expression (1), then it is more desirable from the foregoing description to display a two-dimensional image having the original resolution of the display panel 2a without conducting processing.

Image processing for displaying an image on the stereoscopic image display apparatus will now be described with reference to FIG. 3.

As already described, a plurality of sheets of parallax image are subjected to tile format conversion (step S4). In the tile format, parallax images are arranged sequentially in a tile form. Bringing about this state causes correlation between adjacent pixels in the same pixel. Even if decompression is conducted after compression to restore the original image, therefore, great degradation is not noticed.

As for a two-dimensional image from which a character image and a killer pattern are detected, all parallax same image display is conducted. Accordingly, a plurality of sheets of image are needed to convert parallax images to the tile format. In the case of a two-dimensional image, it is desirable to copy one image and use the copied image. The elemental image array is an image of a final form displayed on the stereoscopic image display apparatus. The elemental image array is obtained by extracting image data corresponding to one pixel in the same location in a plurality of parallax images and displaying a resultant image on the back of one pixel of the 3D resolution.

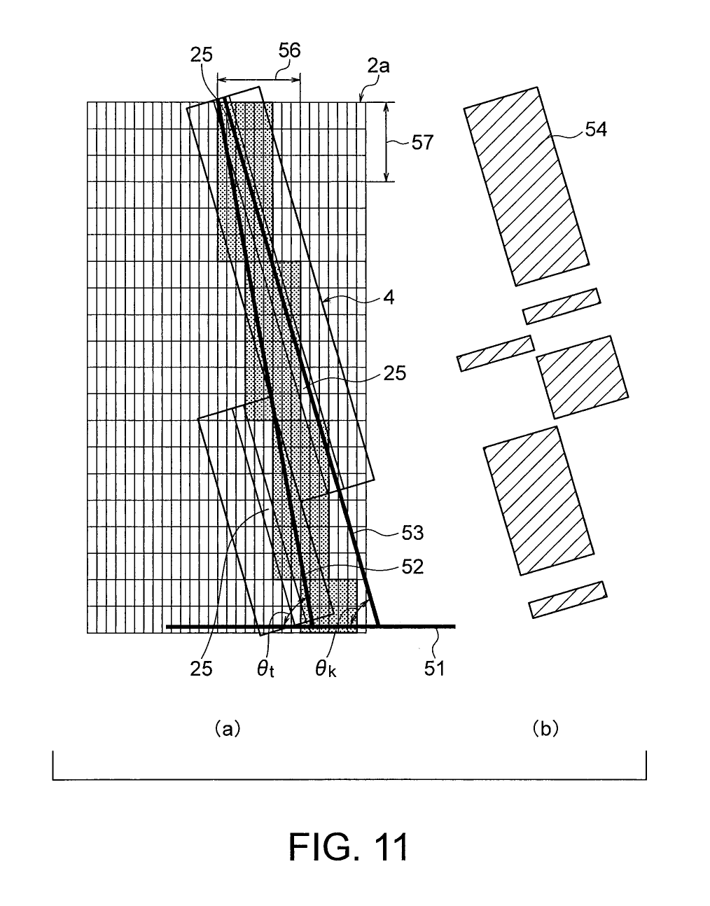

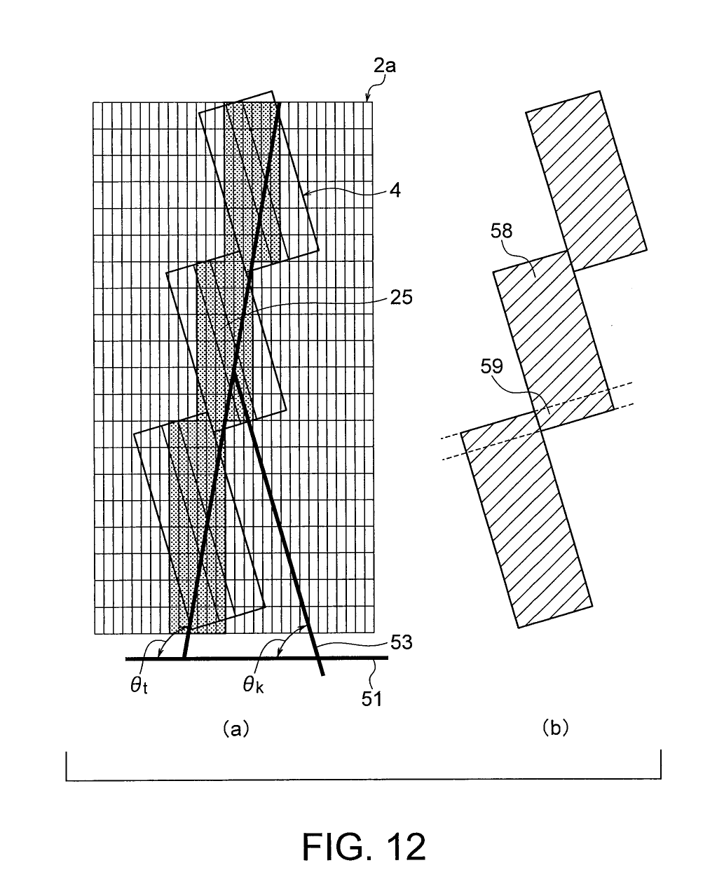

A ground for making an analysis using Expression (1) will now be described with reference to FIG. 11(a) to FIG. 12(b). FIGS. 11(a) and 11(b) are diagrams showing an example in which an absolute value of a difference between an inclination angle θₖ of a lens and an inclination angle θₜ of a straight line on a plane display device is less than 20 degrees. FIGS. 12(a) and 12(b) are diagrams showing an example in which an absolute value of a difference between an inclination angle θₖ of a lens and an inclination angle θₜ of a straight line on a plane display device is greater than 20 degrees.

First, the cause of display degradation according to the inclination of the lens 4 and an angle of a line segment displayed with the resolution of the display panel without processing will be described.

FIG. 11(a) shows a case where an angle (an inclination angle θₜ of the line segment) formed by a center axis 52 of the line segment and a negative direction of an x-axis 51 is 80 degrees and an angle (an inclination angle θₖ of the lens 4) formed by a center axis 53 of the lens 4 and the negative direction of the x-axis 51 is 71.6 degrees. In this case, it follows that |inclination of lens−inclination of line segment|=8.4 degrees. Accordingly, the inclination angle θₜ of the line segment is close to the inclination angle θₖ of the lens 4.

FIG. 11(b) shows an image 54 of the line segment viewed by the viewer beyond the lens array. As for ranges 25 on the display panel 2a into which parallel light rays viewed by the viewer converge in FIG. 11(a), missing parts are generated in the line segment as shown in FIG. 11(b). This is because the ranges 25 in which light rays are converged to stride missing parts and non-missing parts of the line segment alternately when striding adjacent lens arrays. As shown in FIGS. 11(a) and 11(b), a discontinuous part corresponding to two pixels is generated in the longitudinal direction in the case of the 3D resolution, and a discontinuous part corresponding to six pixels is generated in the longitudinal direction in the case of the resolution of the display panel 2a. As a result, degradation is noticed sufficiently. In FIG. 11(a), reference numeral 56 denotes a horizontal width of one pixel in the 3D resolution, whereas reference numeral 57 denotes a vertical width of one pixel in the 3D resolution.

FIG. 12(a) shows a case where an angle (an inclination angle θₜ of the line segment) formed by the center axis 52 of the line segment and the negative direction of the x-axis 51 is 100 degrees and an angle (an inclination angle θₖ of the lens) formed by the center axis 53 of the lens and the negative direction of the x-axis 51 is 71.6 degrees. In this case, it follows that |inclination of lens−inclination of line segment|=28.4 degrees. Accordingly, the inclination angle θₜ of the line segment is not close to the inclination angle θₖ of the lens.

In FIG. 12(a), reference numeral 25 denotes a range in which parallel rays viewed by the viewer converge on the LCD. In FIG. 12(b), an image 58 of the line segment viewed by the viewer beyond the lens array is shown. Unlike FIG. 11(b), missing parts are not generated in the line segment where the lens array is stridden. When displayed on the stereoscopic image display apparatus, a range in which adjacent lens arrays are stridden becomes approximately ⅓ pixel in the 3D resolution as appreciated from FIG. 12(b). Therefore, display degradation of a line segment obtained by displaying the two-dimensional image having the resolution of the display panel 2a without processing is less as compared with FIGS. 11(a) and 11(b). If the line segment shown in FIG. 12 is displayed with the all parallax same image on the display panel 2a, then a display range 59 striding an adjacent lens array becomes wide and more degradation is caused as compared with the case the two-dimensional image having the resolution of the display panel 2a is displayed without processing.

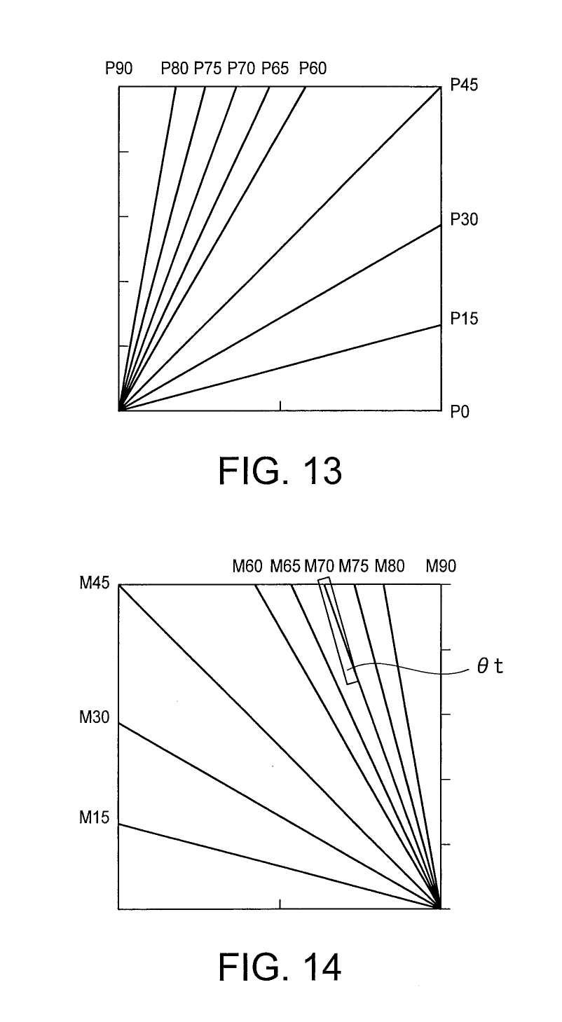

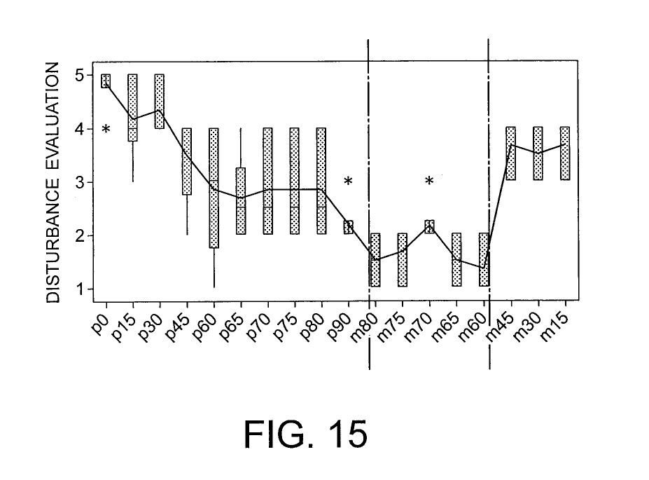

FIG. 13 is a diagram showing images, for various angles, of a straight line having a thickness of two pixels obtained when the straight line inclines to a plus side with the horizontal direction taken as an x axis and the vertical direction taken as a y axis. FIG. 14 is a diagram showing images, for various angles, of a straight line having a thickness of two pixels obtained when the straight line inclines to a minus side with the horizontal direction taken as an x axis and the vertical direction taken as a y axis. As shown in FIGS. 13 and 14, two kinds of image are generated by changing an angle of a line segment pattern having a thickness which is two pixels with the resolution of the display panel 2a (⅔ pixels with the 3D resolution). Line segments P each having a plus inclination angle are shown in FIG. 13. Line segments M each having a minus inclination angle are shown in FIG. 14. Line segments which are respectively 0, 15, 30, 45, 60, 65, 70, 75, 80 and 90 degrees in angle formed with respect to the x axis are shown. Subjective evaluation is conducted when viewed beyond the lens by using the following degradation measures. FIG. 15 shows results of disturbance evaluation according to the inclination angle of the line segment. The degradation measures are:

1) very obstructive;

2) obstructive;

3) not obstructive although be anxious;

4) not anxious although be noticeable;

5) not noticeable.

Averages of subjective evaluation values are represented by a broken line graph. Each of error bars in the longitudinal axis direction indicates a range that fall between 25% and 75% of evaluation values. As appreciated from FIG. 15 simultaneously, the evaluation average of the broken line graph does not vary from the range of the evaluation values.

The angle θₜ which makes the degradation measure equal to 2 or less, i.e., brings about evaluation that the degradation is obstructive is in the range of

60 degrees<θₜ<100 degrees (2)

for the case of line segments which extend in the minus direction of the x axis.

The inclination angle θₖ of the lens is 71.6 degrees. Therefore,

51.6 degrees<θₜ<91.6 degrees

i.e.,

(inclination angle of the lens θₖ=71.6 degrees)−20 degrees≦θₜ≦(inclination angle of the lens θₖ=71.6 degrees)+20 degrees (3)

is used as the analysis condition. In other words, it is appreciated that the viewer feels the display degradation greatly if a fine line segment having a high resolution is displayed when the condition (3) is satisfied. This is true of the pattern edges as well. Although repeated, therefore, it is more desirable to conduct the all parallax same image display when the following relation is satisfied.

|inclination of pattern edge−inclination of lens|≦20 degrees (1)

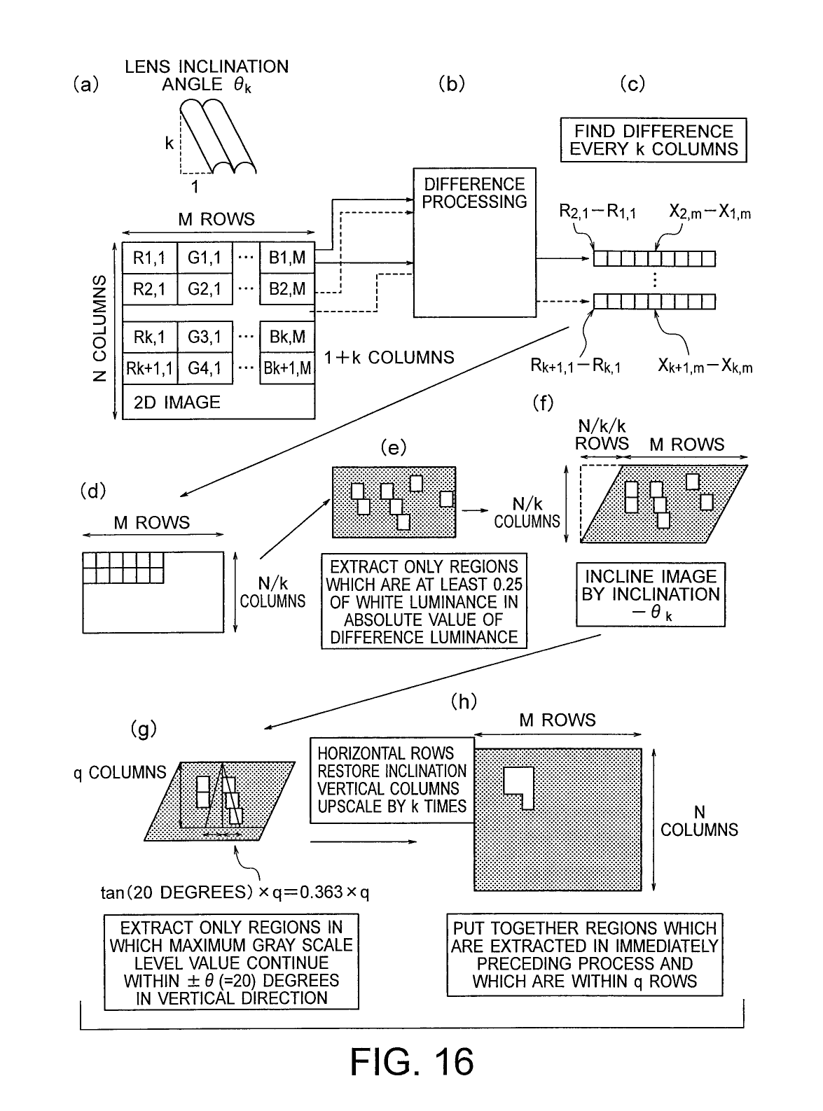

A method for detecting the inclination of the pattern edge will now be described with reference to FIG. 16.

The stereoscopic image display apparatus according to the present embodiment includes decision means. When displaying a two-dimensional image having no parallax as image information, the decision means makes a decision as regards an image pattern of information of the two-dimensional image whether a condition that an inclination angle of a pattern edge coincides with an inclination angle of the lens with a deviation of ±20 degrees or less and the pattern edge in the two-dimensional image continues over at least 20 lines in the vertical direction is satisfied. This decision means includes means which finds a region satisfying the condition. When displaying the two-dimensional image on the stereoscopic image display apparatus, the all parallax same image display is conducted only in a region satisfying the condition whereas display is conducted with the same resolution as that of the display panel 2a having the pixel structure located on the back of the lens in regions where the condition is not satisfied.

The reason why the condition that the discontinuous plane of the pattern edge continues over at least 20 lines is used as a criterion for degradation detection will now be described.

In FIG. 11, the pattern edge continues over 20 lines in the vertical direction. If the condition of (1) is satisfied, there are one or two parts where the pattern becomes discontinuous over two lines as shown in FIG. 11(b). As an exception, if |inclination of pattern edge−inclination of lens|=0 degree, there are no discontinuities at all and the degradation becomes small. As appreciated from FIG. 11, the number of discontinuities becomes small, for example, 1 or 0 for 20 lines or less.

Recently, development of high definition display has been advanced. In the stereoscopic display apparatus, the number of horizontal pixels is assigned to the number of parallaxes and consequently the high definition display is used. A representative subpixel pitch (pitch of each of R, G and B) is set equal to 60 μm. In that case, the length of 20 lines is estimated as follows:

20×0.06×3=3.6 mm

3.6 mm is approximately 10.5 point which is a size of character, and the degradation can be recognized visually.

Hereafter, this processing method will be described with reference to FIG. 16.

First, a method for extracting a region including a pattern edge inclined by ±20 degrees with respect to the inclination angle θₖ of the lens array will now be described. FIG. 16(a) shows a 2D image having a resolution of M rows by N columns to be displayed. Extraction is conducted according to a procedure described hereafter.

(1) A two-dimensional image corresponding to one line in the horizontal direction is input to a line memory every sub pixel (red, green and blue) (FIG. 16(a)).

(2) Pixels of the next line and a preceding line of pixels stored in the line memory are input to a difference circuit. The difference circuit finds a difference absolute value of the gray scale level difference (FIG. 16(b)). Since only the absolute value of the gray scale level difference is necessary at this time, information as to whether the gray scale level difference is plus or minus is not left. The absolute value of the difference gray scale level also becomes equal to the original resolution in the number of bits.

(3) The difference absolute value is mapped to image data as new data. The operation is continued until N/k columns are finished (FIG. 16(c)).

(4) Image data of M rows by N/k columns are generated (FIG. 16(d)).

(5) Only parts of difference absolute value image data which is in gray scale level at least 0.25 (threshold for pattern edge extraction) of the highest value (hereafter referred to as maximum gray scale level value) are extracted, and are provided with the maximum gray scale value. Other parts are provided with the lowest value of the gray scale level (hereafter referred to as minimum gray scale level value) (FIG. 16(e)). There are a large number of pattern edge extraction methods, and they may be used. When the gray scale level difference value is, for example, at least 0.25 of the gray scale level having the highest luminance, the following technique can be used approximately.

| | Decimal | Binary |
|---|---|---|
| Maximum gray scale | 255 | 1111111 |
| level value | | |
| Threshold for edge | 64 | 0100000 |
| extraction | | |

As shown in Table, the threshold can be extracted simply by extracting image data which assumes 1 in the second most significant bit.

(6) Image data is inclined by k in the horizontal direction so as to take the shape of a parallelogram (FIG. 16(f)). At the same time, the region of the maximum gray scale level value is also inclined by k.

(7) Only a region where the highest value of the gray scale level continues in q columns in the vertical direction and within an inclination of +θ(=20) degrees is extracted. In other words, only a region where the maximum gray scale level value continues as a straight line in a range within ±tan(20 degrees)×q=0.363×q in the horizontal direction when the location advances by q columns in the vertical direction is provided with the maximum gray scale level value. Regions which do not satisfy the condition are provided with the minimum gray scale level value (FIG. 16(g)).

A relative region where the pattern edge is in the range of lens inclination ±20 degrees and degradation becomes large if the 2D resolution is displayed with high definition can be extracted with respect to the whole image by following the procedures (1) to (7).

(8) Inclination of horizontal rows is restored, and vertical columns are expanded to k times. In the region of the maximum gray scale level value as well, inclination of horizontal rows is restored and vertical columns are expanded to k times, at that time (FIG. 16(h)). According to (8), an actual distribution range of the region in (7) is appreciated by restoring the whole image to the resolution of the original two-dimensional image.

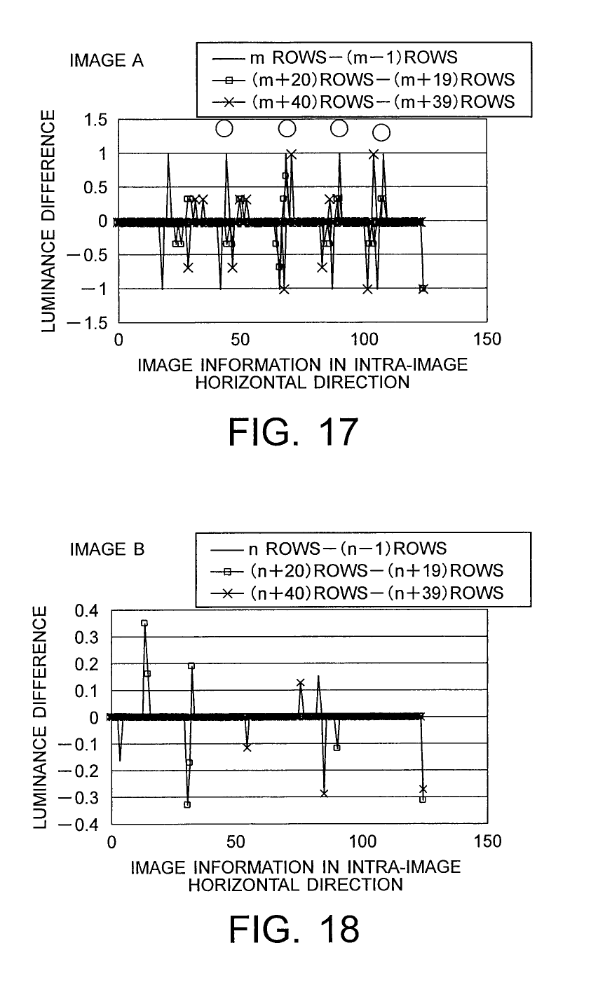

FIG. 17 is a diagram showing difference data of the number of gray scale levels in the vertical direction, in image information in the horizontal direction in an image in a certain region of image data. FIG. 18 is a diagram showing difference data of the number of gray scale levels in the vertical direction, in image information in the horizontal direction in an image in a certain region of image data. FIGS. 17 and 18 show results obtained by conducting the processing shown in FIG. 16(f) on actual image data. Specifically, a relative value of a gray scale level of horizontal pixels compared with the maximum gray scale level value is indicated every 20 rows. As regards three lines in the mth column, the (m+21)st column and the (m+42)nd column shown in FIG. 17, the processing of (7) is conducted. A region which is in gray scale level at least 0.25 as compared with the maximum value is extracted, and only a region where the maximum gray scale level value continues within ±θ(=20) degrees in the vertical direction is extracted. In the shift range of the lens inclination ±20 degrees in the 21st column, the threshold in the horizontal direction becomes

21×0.363=7.62 rows.

In the shift range of the lens inclination ±20 degrees in the 42nd column, the threshold in the horizontal direction becomes

42×0.363=15.25 rows.

If a region is in a range of ±8 rows or less in the 21st column or in a range of ±16 rows or less in the 42nd column, therefore, the pattern edge is in a range of the lens inclination ±20 degrees and degradation becomes remarkable when display is conducted with a 2D resolution of high definition.

In FIG. 17, five peak groups are observed. When the location shifts by 42 columns in the vertical direction, the leftmost peak shifts by 16 rows in the horizontal direction, the second leftmost peak shifts by 8 rows in the horizontal direction, the third leftmost peak shifts by 3 rows in the horizontal direction, the fourth leftmost peak shifts by −4 rows in the horizontal direction, and the fifth leftmost peak shifts by −4 rows in the horizontal direction. Therefore, it is presumed that degradation occurs if a high definition two-dimensional image is displayed in coordinates where the second leftmost, the third leftmost, the fourth leftmost or the fifth leftmost peak value is assumed. If an image having the same resolution as that of the display panel 2a disposed on the back of the lens 4 is actually displayed, subjective evaluation indicates that display degradation has occurred.

As regards three lines in the mth column, the (m+21)st column and the (m+42)nd column shown in FIG. 18, the processing of (7) is conducted. A region which is in gray scale level at least 0.25 as compared with the maximum value is extracted, and only a region where the maximum gray scale level value continues within ±θ(=20) degrees in the vertical direction is extracted. In FIG. 18, there are no regions where the above-described conditions are satisfied. Therefore, it is presumed that degradation does not occur if a high definition two-dimensional image is displayed. If an image having the same resolution as that of the display panel 2a disposed on the back of the lens 4 is actually displayed, subjective evaluation indicates that display degradation has not occurred.

Heretofore, the case of the oblique lens has been described. In the case of a vertical lens as well, however, it is desirable to regard it as the case where the inclination of the oblique lens is 90 degrees and conduct similar filter and image processing.

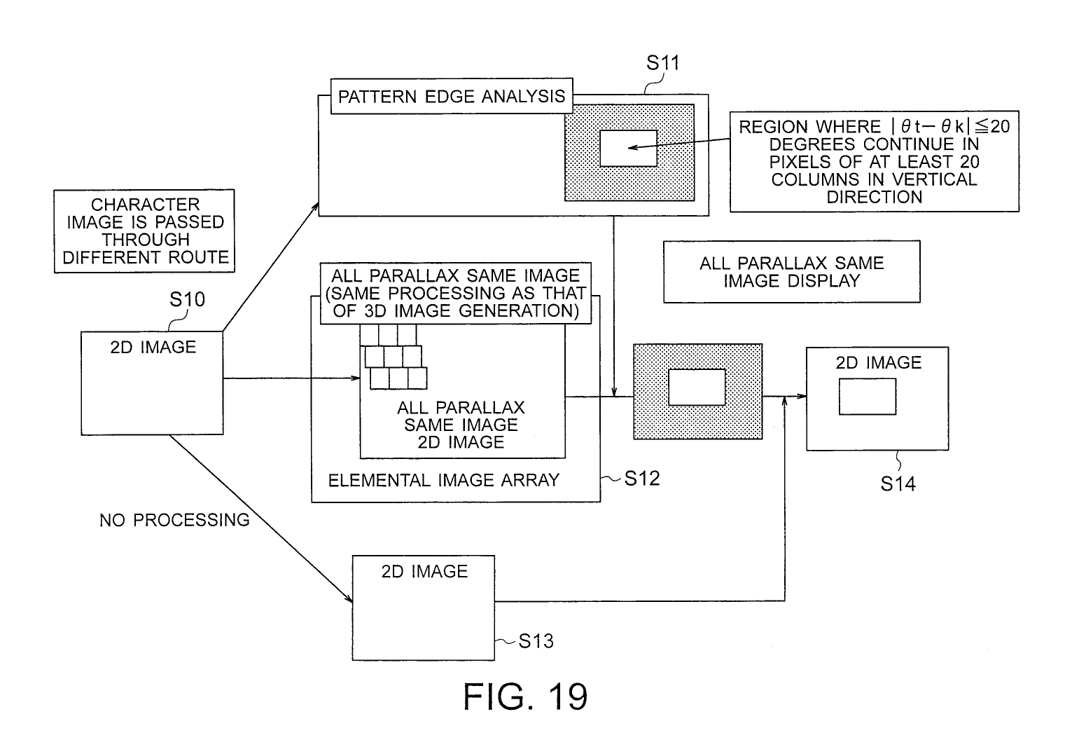

A block diagram concerning a partial all parallax same image display method among methods described heretofore is shown in FIG. 19. In display of the 2D image, there are three processes described below. In a first process, a) a pattern edge analysis of the 2D image is conducted at step S11. If there is a killer pattern satisfying Expression (1), the all parallax same image display is conducted only in a part where the killer pattern is detected whereas high definition LCD display is utilized in regions other than the killer pattern (step S11). As a result, display degradation of the two-dimensional image can be made slight. In this case, the above-described analysis and the processing for converting the two-dimensional image to the all parallax same image are conducted at the same time, as shown in FIG. 19. At a final step, an image is overwritten only in a region of the killer pattern analysis part of the all parallax same image with the resolution of the plane display device which is the LCD (step S14). As a second process, b) the same processing as that of the 3D image is conducted and the all parallax same image is generated and displayed (step S12). As a third process, c) the 2D image is displayed as it is without processing (steps S13 and S14).

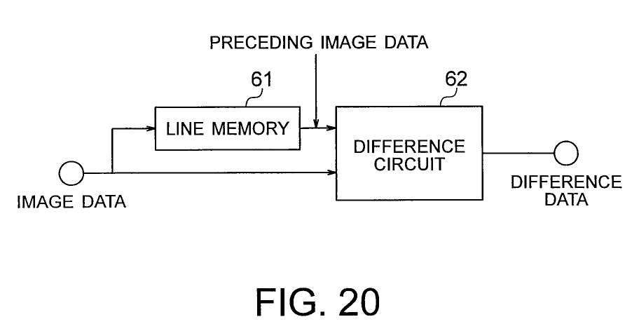

FIG. 20 shows a technique of conducting the difference processing simply by using a circuit. Image data corresponding to one column in the vertical direction are stored in a line memory 61 successively. When image data corresponding to the next column in the vertical direction is read into the line memory 61, a difference circuit 62 finds a difference between the image data corresponding to the next column and the preceding image data stored in the line memory 61 earlier, and outputs the difference as difference data.

According to the present embodiment, it is possible to generate an optimum two-dimensional image according to the image kind as heretofore described.

In BACKGROUND OF THE INVENTION, it has been described to assign pixels of the plane display device itself to parallax images in autostereoscopic display. And it is optimum to apply the present invention to a stereoscopic display apparatus in a range of several parallaxes to ten and several parallaxes using the II scheme. The reason is as follows. In the II scheme, a plurality of parallaxes are included between eyes in many cases. When the head is shaken, image skip is few. Even if one two-dimensional image is displayed as a parallax image, therefore, image skip is few.

The present invention is applicable to a stereoscopic image display apparatus which is not equipped with the 2D/3D changeover function of the optical plate as hardware. Furthermore, the present invention is applicable to a stereoscopic image display apparatus equipped with the 2D/3D changeover function as well when a two-dimensional image is displayed in the 3D mode.

According to the embodiments of the present invention, it is possible to provide a stereoscopic image display apparatus capable of generating an optimum two-dimensional image according to the image kind as heretofore described.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A stereoscopic image display apparatus comprising:
a plane display device comprising a display panel formed of pixels arranged in a matrix form and an image display controller which controls an image displayed on the display panel;
an optical plate comprising a plurality of lenses provided in front of the display panel and controlling light rays illuminated from the pixels;
a display mode selector configured to select one of stereoscopic image display and two-dimensional image display as a display mode;
an analyzer configured to analyze image information contained in a two-dimensional image displayed based on a display information and determine whether to process the two-dimensional image when two-dimensional image display as a display mode be selected; and
an image processor configured to process the two-dimensional image based on a result of the analysis conducted by the analyzer, send the processed two-dimensional image to the image display controller, and cause the image display controller to display the processed two-dimensional image on the display panel.

2. The apparatus according to claim 1, further comprising:
a character detector configured to detect whether the a character is included in the two-dimensional image,
wherein
if the character is detected by the character detector, the image processor cuts out the two-dimensional image with a resolution of the stereoscopic image display, duplicates the two-dimensional image cut out as all parallax same image, and conducts mapping to elemental images with the same display as the stereoscopic image display or upscales the character image by the number of horizontal parallaxes in the horizontal direction and by the number of vertical parallaxes in the vertical direction.

3. The apparatus according to claim 2, wherein
if a character is not included in the two-dimensional image, the image processor detects an inclination angle of a pattern edge of the two-dimensional image with respect to the display panel,
if a condition that a difference between the inclination angle of the pattern edge of the two-dimensional image with respect to the display panel and an inclination angle of the lenses of the optical plate with respect to the display panel is within ±20 degrees and the pattern edge of the two-dimensional image continues over at least 20 lines in the vertical direction is satisfied, then the image processor downscales the two-dimensional image to a resolution of a stereoscopic image, and sends the downscaled two-dimensional image to the image display controller,
if the condition is not satisfied, then the image processor sends the two-dimensional image to the image display controller,
if the image display controller receives the two-dimensional image downscaled to the resolution, the image display controller duplicates the two-dimensional image downscaled to the resolution so as to cause all parallax images to become the same image, then conducts mapping to elemental images with the same display as the stereoscopic image display, conducts display on the display panel over the whole screen corresponding to the resolution, and displays the two-dimensional image which does not satisfy the condition as it is on the display panel over the whole screen corresponding to the resolution.

4. The apparatus according to claim 2, wherein
the image processor comprises:
inclination angle detector configured to detect an inclination angle of a pattern edge of the two-dimensional image with respect to the display panel when a character is not included in the two-dimensional image; and
a region detector configured to detect a region satisfying a condition that a difference between the inclination angle of the pattern edge of the two-dimensional image with respect to the display panel and an inclination angle of the lenses of the optical plate with respect to the display panel is within ±20 degrees and the pattern edge of the two-dimensional image continues over at least 20 lines in the vertical direction,
if the condition that a difference between the inclination angle of the pattern edge of the two-dimensional image with respect to the display panel and an inclination angle of the lenses of the optical plate with respect to the display panel is within ±20 degrees and the pattern edge of the two-dimensional image continues over at least 20 lines in the vertical direction is satisfied, then the image processor generates all parallax same image only in the region satisfying the condition,
as for regions where the condition is not satisfied, the image processor conducts conversion so as to obtain the same resolution as the plane display device, sends a resultant image to the image display controller, and causes the resultant image to be displayed on the display panel.

5. The apparatus according to claim 1, wherein
the analyzer is configured to receive the display information from a profile including a display resolution.
